(19) United States
(12) Patent Application Publication
(10) Pub. No.: US 2010/0185831 A1
(43) Pub. Date: Jul. 22, 2010

(54) SEMICONDUCTOR INTEGRATED CIRCUIT AND ADDRESS TRANSLATION METHOD

(75) Inventor: Akira Iguchi, Kanagawa (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/689,625

(22) Filed: Jan. 19, 2010

(30) Foreign Application Priority Data
Jan. 21, 2009 (JP) 2009-011147

(51) Int. Cl. G06F 12/10; G06F 12/00

(52) U.S. Cl. 711/207; 711/E12.001; 711/E12.061

(57) ABSTRACT

A semiconductor integrated circuit incorporating an address translation section has a micro TLB, a main TLB and a CPU. The CPU reads out, at the time of process switching, a TLB entry having a private mapping of a pre-switching process from the micro TLB, stores the read TLB entry in a corresponding TLB entry storage area in a TLB context storage section having a plurality of TLB context storage areas in each of which a TLB entry having a private mapping of each of a plurality of processes is stored as a context of a TLB, reads out a TLB entry having a private mapping of a post-switching process from the TLB context storage section, and writes the read TLB entry into the main TLB.

### CROSS-REFERENCE TO RELATED APPLICATION

This application is based upon and claims the benefit of priority from the prior Japanese Patent Application No. 2009-011147 filed in Japan on Jan. 21, 2009, the entire contents of which are incorporated herein by reference.

### BACKGROUND OF THE INVENTION

1. Field of the Invention

The present invention relates to a semiconductor integrated circuit and an address translation method.

2. Description of Related Art

Conventionally, in many cases, a computer includes a central processing unit (hereinafter referred to as CPU) and a memory management unit (hereinafter referred to as MMU) which has an address translation function to translate a virtual address into a physical address. Information on address translation from a virtual address to a physical address, more specifically information on correspondence relation between a virtual address and a physical address is stored in an address translation table in a main memory.

When the CPU accesses the main memory, the address translation table is referred to. However, the overhead increases when memory access to the main memory is performed for reference to the address translation table each time the address translation is performed. In ordinary cases, therefore, a part of information on the address translation table is cached in an address translation buffer (translation link-aside buffer (TLB)) as a so-called cache.

When a target entry is found in the TLB, a TLB hit occurs. In the event of a TLB hit, the above described memory access becomes unnecessary, so that high-speed address translation can be realized. When no entry is found in the TLB, that is, in the event of a TLB miss, memory access to the main memory is made by means of hardware or software, and necessary information is read from the address translation table and refilled in the TLB.

In recent years, a multilayered TLB of a high speed and a large capacity has been realized. More specifically, the multilayered TLB is configured of two layers: a micro TLB of a high speed and a small capacity, and a main TLB of a low speed and a large capacity. In the case of instruction fetch and data access, a procedure is taken in which the micro TLB is first accessed and, if an entry corresponding to a virtual address is not found in the micro TLB, the main TLB is accessed. Further if the entry is not found in the main TLB, TLB miss processing, such as refill processing, is performed by means of hardware or software.

Generally, in a case where a plurality of processes runs, an independent virtual address space is assigned to each of the processes. The correspondence between virtual addresses and physical addresses varies among the processes. When switching is performed between the processes, there is a need to change address translation information as well. There is, therefore, a problem that it is necessary to invalidate all TLB entries at the time of switching between the processes.

Conventionally, there is a method in which a process identifier is additionally recorded in each TLB entry and only the entry related to a process under execution is referred to at the time of address translation, whereby the overhead of invalidation processing on the entire TLB is reduced.

That is, a process identifier matching condition is added as a TLB matching condition to inhibit reference to TLB entries unrelated to a process under execution, thereby eliminating the need for invalidation processing on TLBs at the time of process switching. Also, when execution of the preceding process stopped by switching is again started, a TLB entry referred to at the preceding time of execution may remain Therefore this method also has the effect of improving the TLB hit rate.

Concrete examples the identifier are an application space identifier (ASID) in an ARM processor described in “ARM Architecture Reference Manual” (by ARM limited, ARM Architecture Reference Manual, issued in 2005, ARM Limited), a logical partition identifier (LPID) in a PowerPC processor described in “PowerPC Operating Environment Architecture Book III Version 2.02” (by J. Wetzel et al., PowerPC Operating Environment Architecture Book III Version 2.02, issued in 2005, IBM Corp.), and a virtual processor identifier (VPID) in an IA32 processor.

Further, techniques using an independent TLB for each process are proposed in Japanese Patent Application Laid-Open Publication Nos. 11-7411, 2005-346358, and 04-205636.

It is also possible to further improve the TLB hit rate by using the proposed techniques. Providing an independent TLB for each process, however, requires provision of a plurality of TLBs on an LSI and entails not only a problem in cost but also a problem that the circuit scale is increased.

### BRIEF SUMMARY OF THE INVENTION

According to one aspect of the present invention, a semiconductor integrated circuit having an address translation section configured to translate a virtual address at a time of access from a CPU to a main memory into a corresponding physical address can be provided, the address translation section including a first address translation buffer configured to store a TLB entry having information on a correspondence relation between the virtual address and the physical address; a second address translation buffer configured to store a TLB entry having information on the correspondence relation between the virtual address and the physical address; and a storage capacity is larger than the storage capacity of the first address translation buffer, and a control section configured to read out, at a time of process switching, a TLB entry having a private mapping of a pre-switching process from the first address translation buffer, to store the read TLB entry in a TLB context storage section which store a read TLB entry correspond with a private mapping, to read out a TLB entry having a private mapping of a post-switching process from the TLB context storage section, and to write the read TLB entry into the second address translation buffer.

### BRIEF DESCRIPTION OF THE DRAWINGS

FIG. 1 is a diagram for explaining a configuration of an address translator according to an embodiment of the present invention;

FIG. 2 is a diagram showing an example of a format of each entry of address translation information stored in an address translation table according to the embodiment of the present invention;

FIG. 3 is a diagram showing an example of a format of a TLB entry according to the embodiment of the present invention;

FIG. 4 is a flowchart showing an example of a procedure of a TLB reference process at the time of address translation according to the embodiment of the present invention;

FIG. 5 is a diagram showing a configuration of a TLB context storage section according to the embodiment of the present invention; and

FIG. 6 is a flowchart for explaining an example of a procedure of process switching processing according to the embodiment of the present invention.

### DETAILED DESCRIPTION OF THE INVENTION

An embodiment of the present invention will be described with reference to the accompanying drawings.

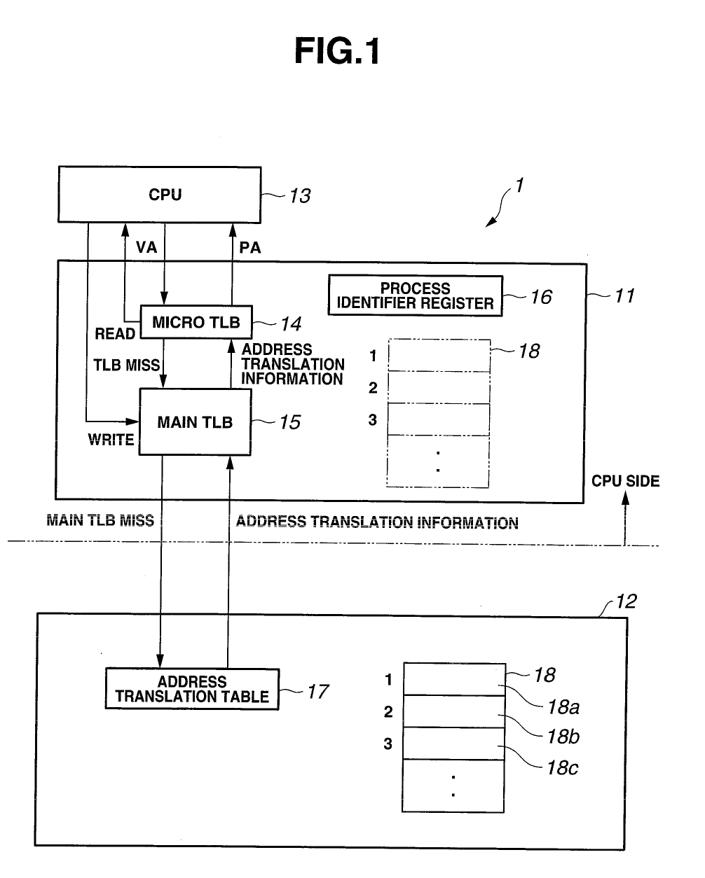

A configuration of a computer apparatus including an address translator according to the present embodiment will first be described with reference to FIG. 1. FIG. 1 is a diagram for explaining a configuration of the address translator according to the present embodiment.

A computer apparatus 1 is configured by including an MMU 11, a main memory 12, and a CPU 13 such as a CPU core. The MMU 11 and the CPU 13 constitute an address translator as an address translation section. The MMU 11 has a multilayered structure in two-stage foam including a micro TLB 14 and a main TLB 15. The storage capacity of the micro TLB 14 serving as a first address translation buffer is smaller than the storage capacity of the main TLB 15 serving as a second address translation buffer. The MMU 11 further includes a process identifier register 16. The micro TLB 14 and the main TLB 15 function as a cache for an address translation table 17 in the main memory 12. The CPU 13 and the MMU 11 constitute an address translation section, are formed as a semiconductor integrated circuit, for example, on a single chip, and are connected to the main memory 12 via a bus (not shown).

In the process identifier register 16 of the MMU 11, an identifier for a process under execution is set by an operating system (hereinafter referred to as OS). Therefore, when switching from the process under execution is performed, the corresponding content in the process identifier register 16 is changed.

Contents of the micro TLB 14 can be read from the CPU 13, and the main TLB 15 is configured to be capable of writing from the CPU 13. That is, the CPU 13 serving as a control section can read the contents of the micro TLB 14 by means of software executed on the CPU 13, and the CPU 13 and the MMU 11 are configured to be capable of writing to the main TLB 15.

Further, the main memory 12 includes a TLB context storage section 18 configured to store, as a context, a micro TLB entry for a pre-switching process recorded in the micro TLB 14 at the time of process switching. The TLB context storage section 18 stores information on the TLB entry in the micro TLB 14 for each of a plurality of processes. In particular, the TLB context storage section 18 has a plurality of TLB context storage areas in which a TLB entry having a private mapping of each of the plurality of processes is stored as a TLB context.

FIG. 1 shows, by way of example, a state where a TLB context of process 1 (P1) is stored in a storage area 18a; a TLB context of process 2 (P2) is stored in a storage area 18b; and a TLB context of process 3 (P3) is stored in a storage area 18c. The address translator is configured by including the micro TLB 14, the main TLB 15, and the TLB context storage section 18.

The TLB context storage section 18 may be provided on the CPU side, for example, in a semiconductor chip in which a CPU core is mounted, as indicated by the double-dot-dash line in FIG. 1.

The micro TLB 14 stores information on the correspondence relations between virtual addresses (VA) and physical addresses (PA). The main TLB 15 also stores information on the correspondence relations between virtual addresses and the physical addresses. However, the main TLB 15 is referred to when there is no information on the physical address corresponding to the desired virtual address in the micro TLB 14.

Accordingly, the micro TLB 14 is first referred to at the time of address translation. If there is no entry having necessary physical address information, i.e., no TLB entry in the micro TLB 14, the main TLB 15 is then referred to. If no TLB entry is found in the main TLB 15 either, the address translation table 17 in the main memory 12 is finally referred to. That is, references are made at the time of address translation in order of the micro TLB 14, the main TLB 15, and the address translation table 17.

The micro TLB 14, which is a higher-level table, can be accessed at a high speed. Therefore, the processing time can be reduced if a TLB entry which is address translation information is found in the micro TLB 14. In particular, access to the main memory 12 is made at a speed much lower than the speed at which access is made to the micro TLB 14 or the main TLB 15. Hence, the system performance can be improved by improving the TLB hit rate.

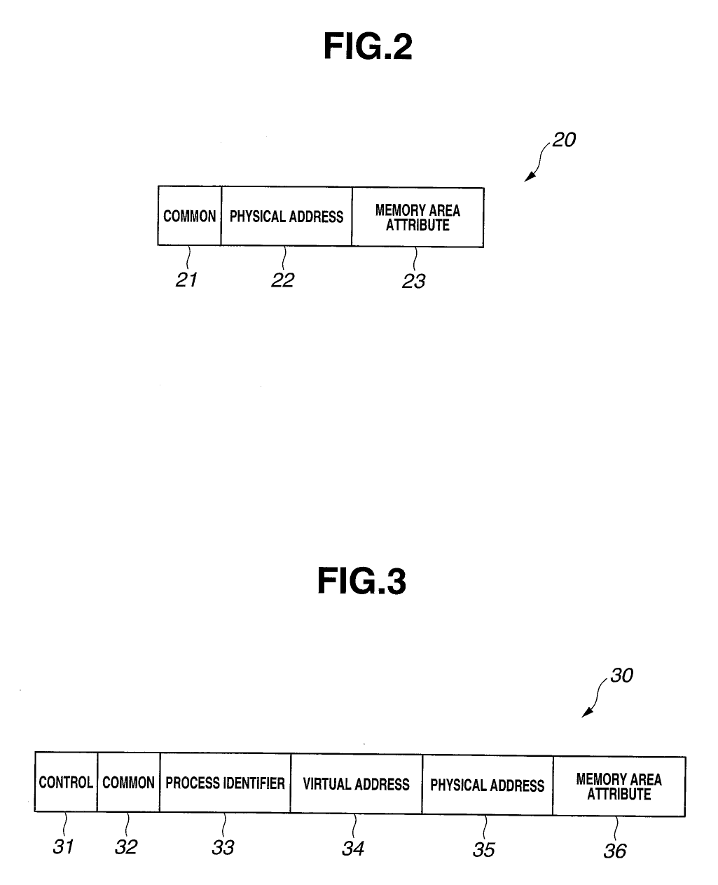

Next, a data structure of the address translation table 17 will be described. FIG. 2 is a diagram showing an example of a format 20 of each entry of address translation information stored in the address translation table 17.

Format 20 of each entry in the address translation table 17, i.e., a translation table entry, is configured by including three fields: a common field 21, a physical address field 22, and a memory area attribute field 23. In the address translation table 17, information on the entry in the format shown in FIG. 2 is stored in correspondence with a virtual address in the virtual address space for each process.

The common field 21 is used to identify a mapping related to the entry as a mapping unique to the process, i.e., a private mapping, or a mapping shared by the other processes or the operating system, i.e., a global mapping. That is, the common field 21 contains attribute information indicating whether or not a mapping related to the entry is a private mapping.

For example, in the OS using in a virtual address space of 4 gigabytes (GB) (in the case of 32-bit virtual address) a first 3 GB area for user processes and the remaining 1 GB area for the kernel, entries for mapping of the 3 GB space used for user processes are mapped as private, while entries for mapping of the 1 GB space used for the kernel are mapped as global.

The common field 21 performs an important function in TLB refill processing and in TLB matching processing.

In TLB refill processing, the common field 21 is used to determine whether or not an identifier for a process under execution is recorded in a TLB entry in FIG. 3 described below. When an entry having a private mapping is refilled in the TLB, the identifier for the process under execution stored in the process identifier register 16 is recorded in a TLB entry. When an entry having a global mapping is refilled in the TLB, the process identifier is not recorded.

Further, in TLB matching processing, the common field 21 is used to determine whether or not the value of the process identifier register 16 is used as a matching condition. The establishment of a match to a TLB entry having a private mapping is recognized only when both a match to a virtual address and a match between the value of the process identifier recorded in the TLB entry and the value of the process identifier register 16 occur. The establishment of a match to a TLB entry having a global mapping is recognized when a match to a virtual address occurs.

Such private mapping is introduced to eliminate invalidation processing on TLBs at the time of process switching performed by the OS and to reduce the overhead.

In the physical address field 22, the physical address of a memory area mapped by the entry is recorded.

In the memory area attribute field 23, attributes (such as access protection, cacheability and page size) of the memory area mapped by the entry are recorded.

Next, a data structure of a TLB entry will be described. FIG. 3 is a diagram showing an example of a format of a TLB entry. A format 30 of a TLB entry is configured of six fields: a control field 31, a common field 32, a process identifier field 33, a virtual address field 34, a physical address field 35 and a memory area attribute field 36.

In the control field 31, information for controlling the TLB entry, such as a validity/invalidity bit of the TLB entry and a reference bit for LRU algorithm, is recorded.

In the common field 32, the value in the common field 21 of the corresponding entry in the address translation table 17 is recorded.

In the process identifier field 33, the identifier for the process under execution at the time of refilling of the TLB entry is recorded.

In the virtual address field 34, a virtual address associated with the corresponding entry in the address translation table 17 is recorded.

In the physical address field 35, the value in the physical address field 22 of the corresponding entry in the address translation table 17 is recorded.

In the memory area attribute field 36, the value in the memory area attribute field 23 of the corresponding entry in the address translation table 17 is recorded.

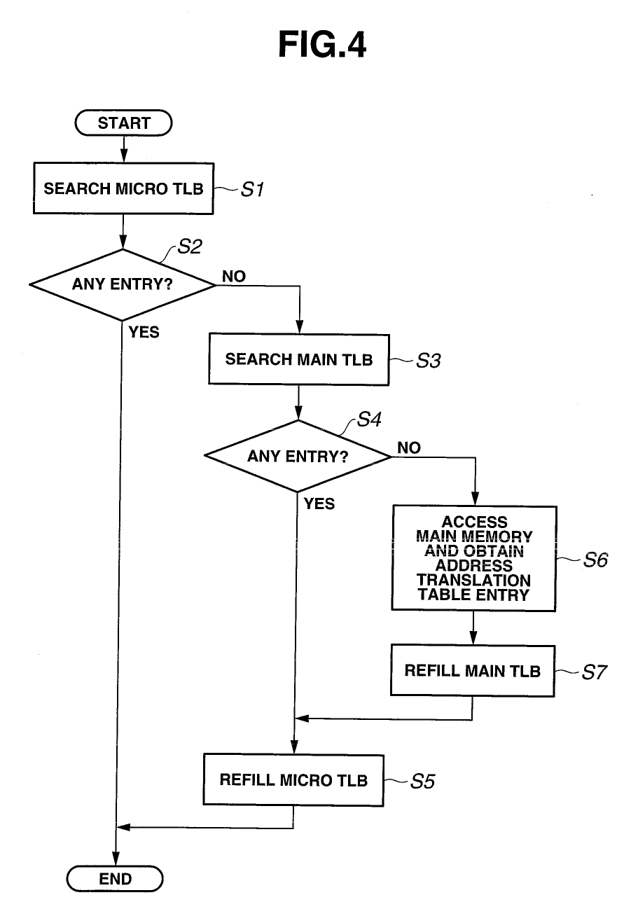

Next, TLB reference processing at the time of address translation will be described. When the CPU 13 performs an instruction fetch or data access, the CPU 13 issues to the MMU 11 an address translation request to translate a virtual address into a physical address, and the MMU 11 refers to the TLB. FIG. 4 is a flowchart showing an example of a procedure of a TLB reference process at the time of address translation.

When a virtual address for address translation is supplied, the MMU 11 first refers to the micro TLB 14, and searches for a TLB entry corresponding to the virtual address (step S1). That is, TLB matching processing in the micro TLB 14 is performed.

As a result of the search, it is determined whether or not a TLB entry corresponding to the virtual address is stored (step S2).

The establishment of a match to a TLB entry having a private mapping is recognized only when both a match to the virtual address and a match between the value of the process identifier recorded in the TLB entry and the value of the process identifier register 16 occur. The establishment of a match to a TLB entry having a global mapping is recognized when a match to the virtual address occurs.

If a matching entry exists in the micro TLB 14 (i.e., in the event of a micro TLB hit), the result of determination in step S2 is YES, referring to the TLB is ended and address translation is performed by using information on the obtained entry.

If no matching entry exists in the micro TLB 14 (i.e., in the event of a micro TLB miss), the result of determination in step S2 is NO and a search for a TLB entry corresponding to the virtual address is then made by referring to the main TLB 15 (step S3). That is, TLB matching processing in the main TLB 15 is performed.

As a result of the search, it is determined whether or not a TLB entry corresponding to the virtual address is stored in the main TLB 15 (step S4).

If a matching entry exists in the main TLB 15 (i.e., in the event of a main TLB hit), the result of determination in step S4 is YES, the entry is refilled in a suitable entry area in the micro TLB 14 (step S5) and address translation is performed by using information on the obtained entry. As an algorithm for determining the entry in the micro TLB 14 refilled at this time, a suitable algorithm, such as a random algorithm or an LRU algorithm, is used.

If no matching entry exists in the main TLB 15 (i.e., in the event of a main TLB miss), the result of determination in step S4 is NO and a translation table entry is obtained by accessing the address translation table 17 in the main memory 12 (step S6). Then, processing to refill the main TLB 15 is performed (step S7).

As a processing method in the event of this main TLB miss, a method in which memory access is automatically made by means of hardware to refill a main TLB entry (a method based on hardware TLB management), a method in which the MMU 11 generates an exception and memory access is made by means of software according to the exception to refill a main TLB entry (a method based on software TLB management), and the like may be mentioned. A suitable one of such methods is used.

Also as an algorithm for determining a TLB entry to be refilled, a suitable algorithm, such as a random algorithm or an LRU algorithm, is used, as in the above-described case of the micro TLB 14.

After refilling of a main TLB entry in step S7, processing for refilling the micro TLB 14 is executed (step S5), as in the case of a micro TLB miss. Address translation is performed by using information on the obtained entry.

After the completion of TLB reference, access control or the like is performed by using memory area attributes in the TLB entry. Processing for this control is an ordinary one, which will not be described in the description of the present embodiment.

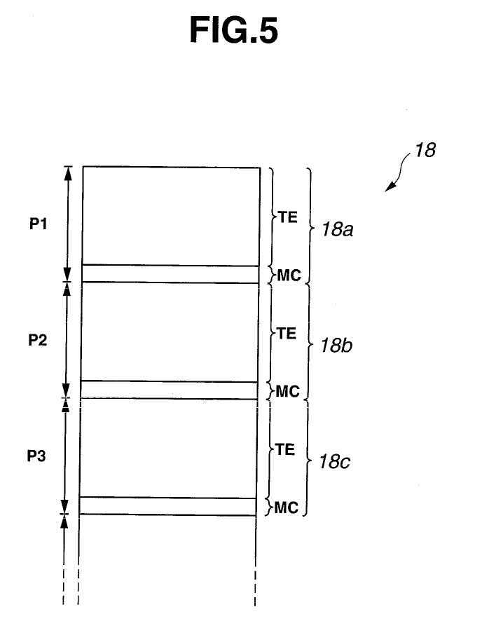

FIG. 5 is a diagram showing a configuration of the TLB context storage section 18. As described above, information on a TLB entry having a private mapping is stored as a TLB context for each process, such that a TLB context of process 1 (P1) is stored in the storage area 18a; a TLB context of process 2 (P2) in the storage area 18b, and a TLB context of process 3 (P3) in the storage area 18c.

Further, each of the storage areas includes a storage area TE in which a plurality of TLB entry data items for the corresponding process is stored, and a storage area MC in which information including a flag indicating the existence of a change made in mapping as described below is stored.

Next, processing when the OS switches processes will be described. In the following description, a process running before switching processing is referred to as “pre-switching process” and a process running after switching processing is referred to as “post-switching process”.

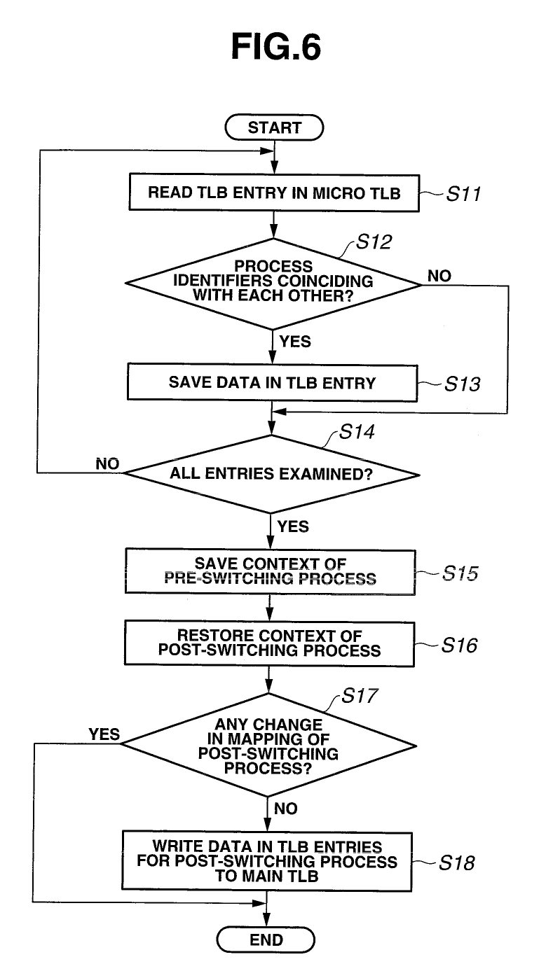

FIG. 6 is a flowchart for explaining an example of a procedure of process switching processing.

When switching processing occurs, the CPU 13 as a control section first reads one TLB entry from the top of TLB entries in the micro TLB 14 (step S11) and determines whether or not the process identifier recorded in the read TLB entry coincides with the process identifier for the pre-switching process (step S12). In the case of coincidence, the CPU 13 sets the data in the TLB entry having a private mapping as a TLB context of the pre-switching process, and saves the data in the storage area in the TLB context storage section 18, whose storage area corresponds to the coincident process identifier (step S13).

TLB contexts may be provided by being stored not in the context storage section 18 but in a storage area in which contexts of processes (hereinafter referred to as “process context”) are stored. That is, the context storage section 18 may be configured by being divided on a process-by-process in such a manner that each divided TLB context data is contained in a storage section for a process context. In such a case, an area having the same size as that of the micro TLB is secured in advance in the process context storage area as the TLB entry data save area of the micro TLB.

Further, in a case where there is a limit to the capacity, i.e., the size, of the storage for process contexts, and where the area for saving all TLB entry data in the micro TLB 14 cannot be secured, the number of TLB entries to be saved may be limited. In such a case, a suitable one of algorithms such as a random algorithm and an LRU algorithm is used as a method for determining TLB entries in the micro TLB 14 to be saved.

Determination is made as to whether or not the process identifiers have been checked in the same way with respect to all the TLB entries in the micro TLB 14 (step S14). If checking of the process identifiers has not been completed with respect to all the TLB entries, the result of determination in step S14 is NO and the process returns to step S11 to perform the above-described processing with respect all the TLB entries.

By saving data in the TLB entries having the matching process identifiers in all the TLB entries in the micro TLB 14, all the TLB entries having the private mapping of the pre-switching process are saved.

As reasons for saving only the TLB entries in the micro TLB 14, the following may be mentioned: 1) the TLB entries in the micro TLB 14 have been referred to most frequently and there is a strong possibility of the TLB entries being referred to after switching, and 2) the micro TLB 14 has such a small capacity that the saving area is not so large. The reason for setting only the private mapping of the pre-switching process as a saving objective is that the possibility of a global mapping being changed during process suspension is high.

Next, the CPU 13 saves the process context of the pre-switching process in the same way as in ordinary process switching processing (step S15). The process context saved in this step is, for example, data in registers of the CPU. Processing with respect to the pre-switching process is thus completed.

Processing with respect to the post-switching process is then performed. The CPU 13 first restores the process context of the post-switching process in the same way as in ordinary process switching processing (step S16).

Next, before restoring the data in the TLB entries for the post-switching process, the CPU 13 checks whether or not any change was made in the private mapping of the post-switching process during suspension of the post-switching process. That is, the CPU 13 determines whether or not any change has been made in the mapping of the post-switching process (step S17).

An example of a change in mapping is a page swap-out or the like. If a change has been made in the mapping, there is a possibility of the TLB entry data saved as the context of the post-switching process becoming false. Therefore, the OS records information such as a flag indicating the existence of a change in the mapping in the corresponding storage area MC in the TLB context storage section 18 (FIG. 5). By checking the data in the storage area MC corresponding to the post-switching process, the CPU 13 can determine whether or not a change has been made in the mapping of the post-switching processing.

Information such as a flag indicating the existence of a change in the mapping may be recorded by being associated with the corresponding process context or being set in the corresponding process context.

If a change in the mapping is detected in checking at the time of process switching, the result of determination in step S17 is YES and the CPU 13 does not restore the TLB entry data. That is, if a change in the mapping has been made, the CPU 13 does not perform read from the TLB context storage section 18 and write to the main TLB 15 with respect to the TLB entries having the private mapping of the post-switching process.

If no change in the mapping is detected, the CPU 13 writes to the main TLB 15 the data in the TLB entries for the post-switching process stored in the TLB context storage section 18 (step S18). As a method of determining the entry area in the main TLB 15 to be overwritten at this time, a suitable one of algorithms such as a random algorithm and an LRU algorithm is used.

As reasons for writing to the main TLB 15 the data in the TLB entries for the post-switching process recording in the TLB context storage section 18, the following may be mentioned: a) because information items on process switching processing presently executed exist in the micro TLB 14, it is undesirable to perform overwrite on these information items, and b) the capacity of the main TLB 15 is larger than that of the micro TLB 14 and the influence of overwrite is small.

By the completion of write to the main TLB 15, process switching processing is completed. The OS then hands over control to the post-switching process and the operation of the post-switching process restarts. When address translation is performed in the state at the time of this restarting, a TLB miss in the micro TLB 14 may occur but the probability of occurrence of a hit in the main TLB 15 is increased in comparison with the case where a process identifier matching condition is simply added to TLB matching conditions as in the related art, because the TLB entries referred to most frequently before switching exist in the main TLB 15.

In the case where the result of determination in step S17 is YES and restoration of the data in the TLB entries is not performed, the contents of each TLB are flushed and, therefore, mishits occur in the micro TLB 14 and the main TLB 15 and reference is made to the address translation table in the main memory 12.

As described above, the address translator according to the above-described embodiment is capable of improving the TLB hit rate with respect to the post-switching process.

In particular, in the case where the TLB context storage section 18 is provided in the main memory 12, addition of only the function to read data in the micro TLB 14 from the CPU 13 and the function to write data from the CPU 13 to the main TLB 15 may suffice and, therefore, an increase in circuit scale on the mounted semiconductor device can be avoided.

According to the above-described embodiment, a semiconductor integrated circuit in which the address translation section capable of improving the TLB hit rate is mounted and an address translation method can be implemented without increasing the circuit scale.

The present invention is not limited to the above-described embodiment. Various changes, modifications and the like can be made in the embodiment without changing the gist of the present invention.

What is claimed is:

1. A semiconductor integrated circuit comprising an address translation section configured to translate a virtual address at a time of access from a CPU to a main memory into a corresponding physical address, the address translation section including:
a first address translation buffer configured to store a TLB entry having information on a correspondence relation between the virtual address and the physical address;
a second address translation buffer configured to store a TLB entry having information on the correspondence relation between the virtual address and the physical address; and a storage capacity is larger than the storage capacity of the first address translation buffer, and
a control section configured to read out, at a time of process switching, a TLB entry having a private mapping of a pre-switching process from the first address translation buffer, to store the read TLB entry in a TLB context storage section which store a read TLB entry correspond with a private mapping, to read out a TLB entry having a private mapping of a post-switching process from the TLB context storage section, and to write the read TLB entry into the second address translation buffer.

2. The semiconductor integrated circuit according to claim 1, wherein the second address translation buffer is configured to be referred to when no information on the physical address corresponding to the virtual address is stored in the first address translation buffer.

3. The semiconductor integrated circuit according to claim 1, wherein the TLB context storage section has a plurality of TLB context storage areas which store the TLB entries; in each TLB context storage area, a TLB entry having a private mapping of each of a plurality of processes is stored as a context of a TLB.

4. The semiconductor integrated circuit according to claim 1, wherein each of the TLB entries in the first and second address translation buffers contains attribute information indicating whether or not the TLB entry is the private mapping.

5. The semiconductor integrated circuit according to claim 1, wherein the TLB context storage section is provided in the main memory.

6. The semiconductor integrated circuit according to claim 1, wherein the TLB context storage section is provided in a semiconductor chip in which the CPU is provided.

7. The semiconductor integrated circuit according to claim 1, wherein the TLB context storage section is provided in a storage area in which contexts of the plurality of processes are provided.

8. The semiconductor integrated circuit according to claim 6, wherein the number of entries for each process in the TLB context storage section is limited.

9. The semiconductor integrated circuit according to claim 1, wherein if the mapping of the post-switching process has been changed, the control section does not perform read of the TLB entry having the private mapping of the post-switching process from the TLB context storage section, and write of the TLB entry having the private mapping of the post-switching process to the second address translation buffer.

10. The semiconductor integrated circuit according to claim 9, wherein information on the existence/nonexistence of the change in the mapping is stored in the TLB context storage section, and the control section determines whether or not the change has been made in the mapping by referring to the information on the existence/nonexistence of the change in the mapping stored in the TLB context storage section.

11. The semiconductor integrated circuit according to claim 9, wherein information on the existence/nonexistence of the change in the mapping is stored in a process context storage section storing contexts of the processes, and the control section determines whether or not the change has been made in the mapping by referring to the information on the existence/nonexistence of the change in the mapping stored in the process context storage section.

12. An address translation method of translating a virtual address at a time of access from a CPU to a main memory into a corresponding physical address, the method comprising:
providing first and second address translation buffers each configured to store a TLB entry having information on a correspondence relation between the virtual address and the physical address, the second address translation buffer having a storage capacity which is larger than a storage capacity of the first address translation buffer;
referring to the first address translation buffer about information on the physical address corresponding to the virtual address;
reading out, at a time of process switching, a TLB entry having a private mapping of a pre-switching process from the first address translation buffer, storing a TLB entry in a TLB context storage section which stores a TLB entry having a private mapping, reading out a TLB entry having a private mapping of a post-switching process from the TLB context storage section, and writing the read TLB entry into the second address translation buffer.

13. The address translation method according to claim 12, wherein each of the TLB entries in the first and second address translation buffers contains attribute information indicating whether or not the TLB entry is the private mapping.

14. The address translation method according to claim 12, wherein at the time of the process switching, a process identifier for the pre-switching process and process identifiers in the TLB entries stored in the first address translation buffer are compared with each other, and the TLB entry matching the process identifier for the pre-switching process is read out from the first address translation buffer and stored in the corresponding TLB entry storage area in the TLB context storage section.

15. The address translation method according to claim 12, wherein the TLB context storage section is provided in a semiconductor chip in which the CPU is provided.

16. The address translation method according to claim 12, wherein the TLB context storage section is provided in a storage area in which contexts of the plurality of processes are provided.

17. The address translation method according to claim 16, wherein the number of entries for each process in the TLB context storage section is limited.

18. The address translation method according to claim 12, wherein if a change has been made in the mapping of the post-switching process, read of the TLB entry having the private mapping of the post-switching process from the TLB context storage section and write of the TLB entry having the private mapping of the post-switching process to the second address translation buffer are not performed.

19. The address translation method according to claim 18, wherein information on the existence/nonexistence of the change in the mapping is stored in the TLB context storage section, and determination as to whether or not the change has been made in the mapping is made by referring to the information on the existence/nonexistence of the change in the mapping stored in the TLB context storage section.

20. The address translation method according to claim 18, wherein information on the existence/nonexistence of the change in the mapping is stored in a process context storage section storing contexts of the processes, and determination as to whether or not the change has been made in the mapping is made by referring to the information on the existence/nonexistence of the change in the mapping stored in the process context storage section.
